(19) United States
(12) Patent Application Publication
(10) Pub. No.: US 2022/0232868 A1
(43) Pub. Date: Jul. 28, 2022

(54) Packaging method for macaroni and cheese meals which includes a moisture resistant flavoring packet

(71) Applicant: Richard Warren Hardman, Whitehouse, TX (US)

(72) Inventor: Richard Warren Hardman, Whitehouse, TX (US)

(21) Appl. No.: 17/157,861

(22) Filed: Jan. 25, 2021

(51) Int. Cl. A23L 27/20; A23L 7/109; B65D 81/18; B65D 5/48; B65D 5/42; B65D 85/22

(52) U.S. Cl. CPC A23L 27/20; A23L 7/109; B65D 81/18; A23V 2002/00; B65D 5/4216; B65D 85/22; B65D 5/48

(57) ABSTRACT

A packaging method for macaroni and cheese meals which includes a conveyance structure, macaroni noodles, a moisture resistant containment package capable of holding a flavoring liquid and a promotional reference to the invention located on the exterior of said conveyance structure.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention relates to a packaging method which introduces new flavoring options to macaroni and cheese dinner meals.

### BACKGROUND OF THE INVENTION

Consumers purchase independently packaged macaroni and cheese packets to prepare as a portion of a larger meal which contains a variety of food types. Alternatively they may also prepare the macaroni and cheese meal alone to serve as its own entree.

The current macaroni and cheese packaging systems include a conveyance structure which houses macaroni noodles along with an independent package containing powdered cheese flavoring.

The consumer removes the macaroni noodles from the conveyance structure adding them to boiling water within a stove top pan, and drains the water after the macaroni noodles soften. The consumer then adds the powdered cheese flavoring and softened noodles in a stirring motion combining the ingredients together. The consumer may also add milk and butter or margarine to the mixture. After all of the ingredients have been combined thoroughly, the meal is ready to serve.

During the process of my patent searching I have found a wide variety of packaging systems in the field of food preparation. A few examples of these systems include patents, EP1988033B1 which contains drawing FIG. 8 illustrating an ingredient package which is located within a larger package. The expulsion of the ingredients is performed by applying manual pressure to the exterior of the packaging structure. See FIG. 9.

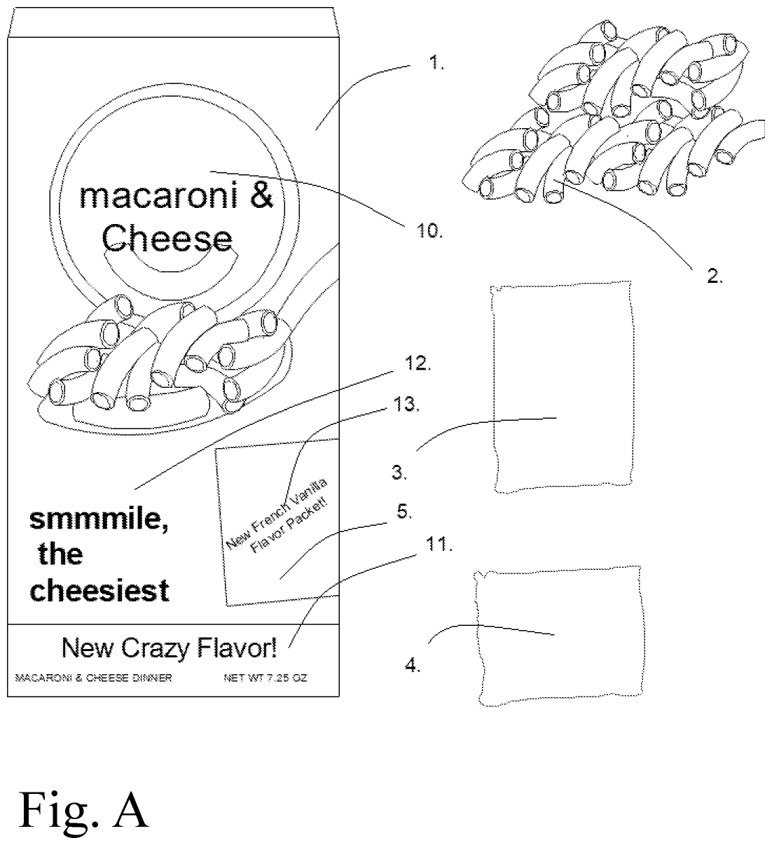

U.S. Pat. No. 5,334,405 is a container closure consisting of 2 membranes one being more permeable than the other. By attaching the less permeable to a first flange at different location than the less permeable membrane, two reservoirs are created within the overall structure of the invention. See FIG. 1, FIG. 2.

U.S. Pat. No. 5,588,561 contains a structure which provides 2 separate areas for mixing to mix dry cereal with milk within a structure capable of being carried to a variety of locations. See FIG. 1, FIG. 2.

U.S. Pat. No. 6,527,110 provides a stored substance being capable of mounting to another structure such as a bottle to dispense the stored substance into the bottle. A breakable seal is provided to seal the substance within the first structure. See FIG. 1.

U.S. Pat. No. 8,151,985 illustrates a container for storing at least two substances which can be mixed comprising two storage chambers being separated by an intervening seal that includes molded threads. See FIG. 1.

U.S. Pat. No. 8,815,318 comprises a two part cup system whereas one section is positioned in the lower extremity of the device and the second section is located in the upper section. Acting as independent reservoirs, they provide a method for transporting ingredients to any variety of locations where they can be mixed together at a later time. See FIG. 1A.

U.S. Pat. No. 8,906,436 comprises a beverage additive cartridge containing an ingredient used with a beverage brewing receiving member which is used to add flavoring to a brewed liquid. See FIG. 1A, FIG. 1B.

U.S. Pat. No. 9,179,750 illustrates a variety of beverage and food container configurations which contain independent storage sections. They are not relevant to my invention. See FIG. 2 and FIG. 3.

U.S. Pat. No. 9,821,951 reflects a packaging assembly which includes a first cartridge containing a liquid medium and a second container which may be removably attached, and may contain the liquid component of the food product being capable of being combined with an insoluble component so as to hold both components together, for consumption by the user. See FIG. 1.

U.S. Pat. No. 10,501,233 depicts a multiple opening container which is capable of simultaneous opening of two or more material compartments which allows for the material contents within the various containing compartments to be mixed together during the process of being poured.

Patent WO2015197496 is entitled LIQUID DAIRY BLEND FOR CULINARY FOOD PRODUCTS and provides a dairy based liquid flavoring substance which is added without an independent moisture proof package and is featured as a sauce to be used in conjunction with other ingredients within a frozen food product. It is known that dairy based ingredients have a limited shelf life unless they are stored in a refrigerated or otherwise frozen state over a period of time so as not to sour. See page 2, paragraph 2.

Non dairy flavoring such as coffee creamers can be stored at room temperatures for long periods of time and come in a wide variety of flavors. My method of packaging may include but is not limited to the same ingredients marketed as coffee creamer. Any flavoring liquid capable of being stored at room temperature will suffice for use within my packaging method.

While the inventors holding the above listed patents provide a wide variety of packaging options, none are specific to the packaging of macaroni and cheese meals and likewise have no provision to add a moisture resistant flavor packet containing at least one compartmental reservoir containing a liquid ingredient capable of a long shelf life for the use with macaroni and cheese meals, nor is there any mention of a promotional graphic relating to an independent moisture resistant flavor packet referred to in pictorial form or by text.

Objects:

One object of my invention is to provide the consumer of macaroni and cheese meals with new flavoring options that are contained within the same conveyance structure as the macaroni noodles and a powdered cheese containing package.

Another object of my invention is to provide a packaging system for macaroni and cheese meals which includes the addition of a moisture resistant flavor packet containing liquid flavoring ingredients which are supplied within the conveyance structure.

Another object of my invention is to provide a moisture resistant flavor packet being capable of containing at least one compartmental reservoir.

Another object of my invention is to provide liquid flavoring ingredients which is capable of flowing solely through gravitational momentum independent of any exterior manipulation to the exterior of the moisture resistant flavor packet after the moisture resistant flavor packet has been opened.

Another object of my invention is to provide liquid flavoring ingredients which have a prolonged shelf life.

Another object of my invention is to provide a promotional reference located on the exterior of the conveyance structure which notates the contents and existence of the liquid flavor packet which is included within the contents of the macaroni and cheese meal conveyance structure.

### SUMMARY OF THE INVENTION

It is therefore an advantage of the present invention to provide a packaging method which provides the consumer with greater choice in their desire for flavoring in relation to macaroni and cheese meals by adding a moisture resistant package which contains a liquid flavoring ingredient along with the ingredients contained within the meals conveyance structure.

These advantages and others are achieved in a packaging method comprising generally of a conveyance structure 1, macaroni noodles 2, a powdered cheese flavor packet 3, an additional moisture resistant package which contains a liquid flavoring ingredient 4, and a promotional mention graphically referring to the new flavoring packet 5 which is located within the conveyance structure, located on the exterior of the conveyance structure where it can be easily observed by the consumer. In the utilization of my invention it may not be necessary to include said powdered cheese flavor 3 with the ingredients of the conveyance structure as it is conceivable that the manufacturer my opt to include cheese flavoring within the liquid ingredients included in the new flavoring packet 5.

Further areas of improvement realized in the present invention will become apparent from the detailed description provided hereafter. It should be understood that the detailed description and the specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. A is a perspective view of a typical macaroni and cheese packaging system including the conveyance structure 1; the macaroni noodles 2; the powdered cheese flavor ingredient 3; and an additional moisture resistant package which contains a flavoring ingredient 4, and a promotional reference to the liquid flavor packet which is presented upon the exterior surface of the conveyance structure 5. 10 illustrates a typical promotional field used In the sales of macaroni and cheese packages which includes an illustration. 11 indicates another location on the exterior promotional surface of a conveyance structure which includes text. 12 provides a textual reference within a promotional field to catch the consumers visual notice. 13 includes an example of an area located on the exterior of the conveyance structure where another promotional reference may be located.

### DESCRIPTION OF THE PREFERRED EMBODIMENTS

I have invented a new packaging method to provide the consumer with additional flavor choices with their purchase of macaroni and cheese meals at their local supermarket.

The following description of the preferred embodiment is merely exemplary in nature and is in no way intended to limit the invention, its application, or its uses.

FIG. A shows a perspective view of a common packaging system for macaroni and cheese meals. My packaging system includes a conveyance structure 1 which internally contains macaroni noodles 2, a powdered cheese ingredient 3, with item 4 identified in FIG. A as an additional moisture resistant package which contains a flavoring liquid.

In a preferred embodiment my packaging method adds a liquid flavor packet within the conveyance structure to accompany the standard ingredients of a macaroni and cheese meal.

The consumer prepares the meal by one of two methods. The first method being to boil water on a traditional stove top burner in a metal pan or in the second method cooking is done in a microwave oven using a microwaveable safe container.

In the first method the macaroni noodles 2 are placed into boiling water and are allowed to remain until softened. In the microwave method, water is added to the macaroni noodles within a microwavable container after which the container and contents are placed into a microwave oven for a time setting specified in the cooking directions. After a period of time the macaroni noodles 2 become soft where after the consumer drains the water from the cooking container and adds the ingredients of the powdered cheese flavoring packet 3 to the macaroni noodles 2 in the cooking container while stirring the contents until they are thoroughly mixed together. With the stove top method of preparation the consumer may add their own milk or margarine or butter and mix the contents together to provide the mixture with a more creamy texture.

Once the previous steps have been completed, the consumer opens the liquid flavoring packet and pours the ingredients into the macaroni and cheese mixture stirring all ingredients together. Upon thorough mixing the meal is ready to be served.

In the purchasing of a macaroni and cheese meal the consumer has a wide variety of options with which to make a decision. To attract the consumers attention the manufacturer will print at least one promotional field on the exterior surface of the packaged components. These promotional fields can be interpreted as areas within the visual display of the overall structure which may graphics including photos or text based phrases.

Kraft macaroni and cheese is a dominant supplier of macaroni and cheese meals and as they are a typical user of promotional practices, I have included a sample of promotional phrases they use within the parameters of my drawings within this patent application.

The promotional samples are noted in the drawings to portray an example of how promotional graphics are used with macaroni and cheese meals. The illustrations provided should not be interpreted as the only phrases or visual attractions that may be used in the execution of my claims. With my invention any area located on the exterior of the conveyance structure can be used to position a promotional graphic, phrase, text or other account identifying the liquid flavoring ingredients located within the conveyance structure.

I claim:

1. A packaging method for macaroni and cheese meals which includes a moisture resistant package consisting of a liquid flavoring ingredient, comprising;
a. a conveyance structure with an interior reservoir capable of holding a variety of independent ingredients and,
b. a volume of macaroni noodles.

2. The moisture resistant package of claim 1 being capable of containing at least one compartmental reservoir.

3. The liquid flavoring ingredient of claim 1 which is capable of a prolonged shelf life.

4. The liquid flavoring ingredient of claim 1 being of a fluidic composition capable of being dispelled from said moisture resistant package through gravitational momentum.

5. The packaging method of claim 1 which includes a promotional account located on the exterior side of said conveyance structure which refers to said liquid flavoring ingredient.
